(19) United States
(12) Patent Application Publication
(10) Pub. No.: US 2009/0218782 A1
(43) Pub. Date: Sep. 3, 2009

(54) HIGH GROUND CLEARANCE AXLELESS VEHICLE

(75) Inventors: Earl Dallas Smith, Greencastle, IN (US); Judson Smith, Greencastle, IN (US)

Correspondence Address: BINGHAM MCHALE LLP, 2700 MARKET TOWER, 10 WEST MARKET STREET, INDIANAPOLIS, IN, 46204-4900, US

(73) Assignee: ALOHA, LLC, Indianapolis, IN (US)

(21) Appl. No.: 12/366,338

(22) Filed: Feb. 5, 2009

Related U.S. Application Data
(60) Provisional application No. 61/026,303, filed on Feb. 5, 2008.

(51) Int. Cl. B60G 3/00

(52) U.S. Cl. 280/124.125

(57) ABSTRACT

A frame and suspension for a high ground clearance truck trailer. Independently moving suspension arms are suspended outboard and rearward on opposing sides of the frame, and wheel spindles are cantilevered outboard and below the frame so as to provide an unobstructed empty volume underneath the frame.

### CROSS REFERENCE TO RELATED APPLICATION

This application claims the benefit of priority to U.S. Provisional Patent Application Ser. No. 61/026,303, filed Feb. 5, 2008, titled HIGH GROUND CLEARANCE AXLELESS VEHICLE, all of which is incorporated herein by reference.

### FIELD OF THE INVENTION

The present invention pertains to vehicle suspension systems that do not have an axle, and in particular, to a suspension system for a truck having high ground clearance between wheels of the payload section.

### SUMMARY OF THE INVENTION

Various aspects of some embodiments of the inventions shown and described herein pertain to a ground vehicle with high road clearance.

Yet other aspects of various embodiments pertain to ground vehicles having independent suspension, with the suspension arms being adapted and configured to support wheels on opposing sides such that the space under the bottom of the frame and between the opposing suspension arms is substantially free of any obstructions.

Yet other aspects of various embodiments pertain to a substantially flat-bottomed vehicle frame that is suspended from a roadway by suspension arms having spindles that are cantilevered outward.

### BRIEF DESCRIPTION OF THE DRAWINGS

FIG. 1-P is a photographic side view of a tractor trailer of an existing design.

FIG. 2-P is a photographic side view of a subchassis according to one embodiment of the present invention.

FIG. 3-P is a photographic end view of the apparatus of FIG. 2.

FIG. 4-P is a photographic view from underneath the apparatus of FIG. 2.

FIG. 5-P is a photographic side view of a portion of the apparatus of FIG. 2.

FIG. 6-P is a photographic view of a portion of the apparatus of FIG. 2.

FIG. 7-P is a rearward, left side photographic view of a suspension arm and frame according to one embodiment of the present invention.

FIG. 8-P is a side photographic view of the apparatus of FIG. 7.

FIG. 9-P is a side photographic view of the apparatus of FIG. 7.

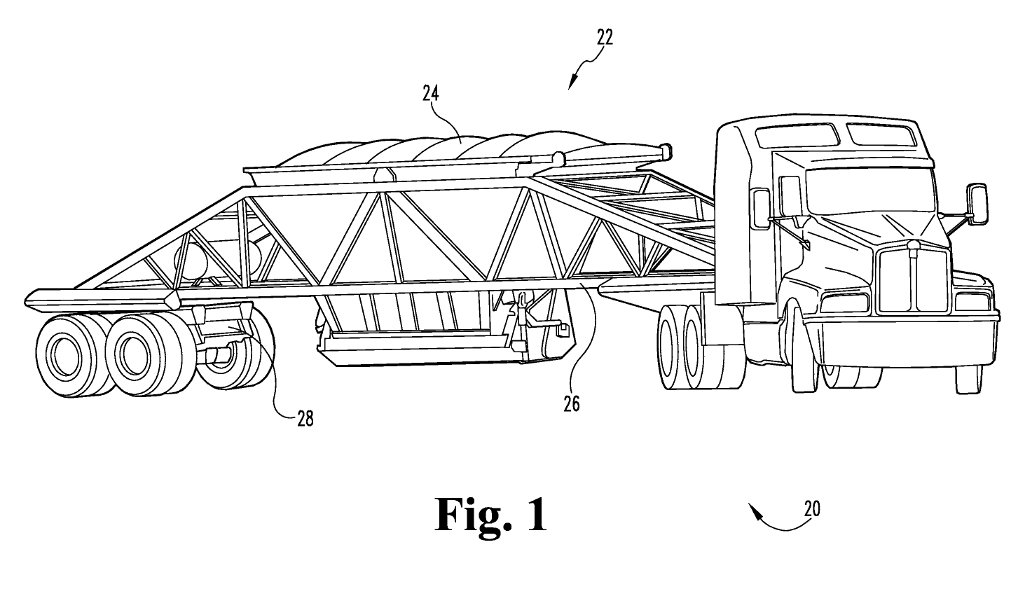

FIG. 1 is a line drawing representation of FIG. 1-P.

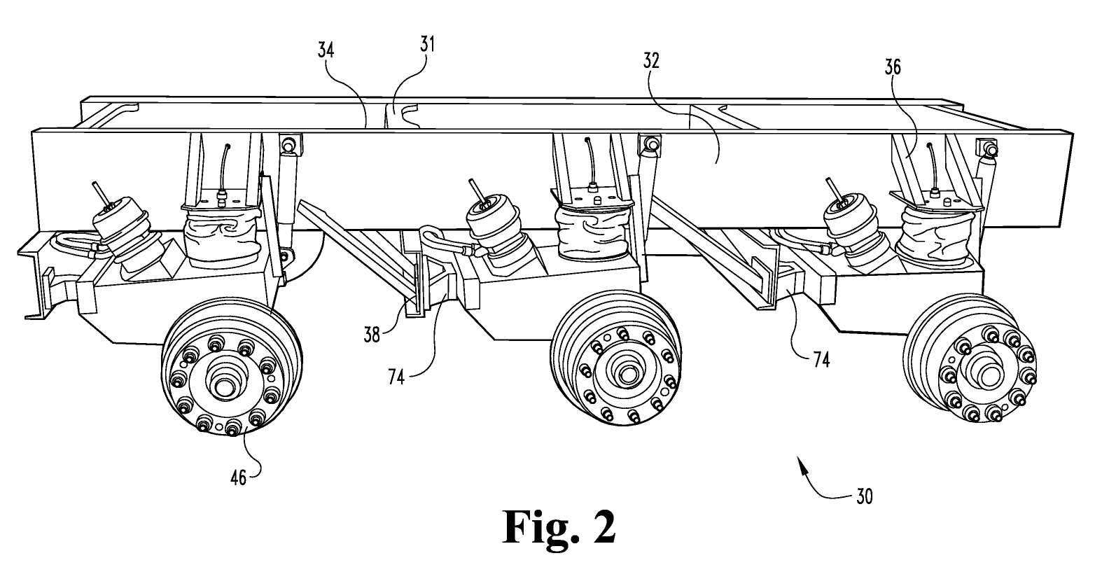

FIG. 2 is a line drawing representation of FIG. 2-P.

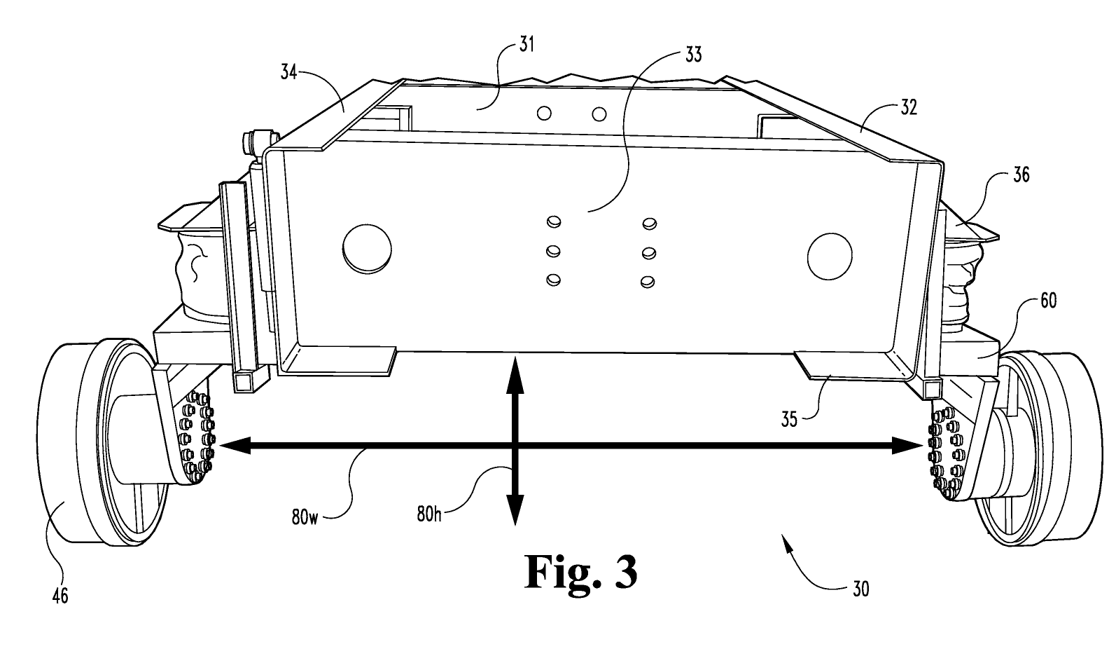

FIG. 3 is a line drawing representation of FIG. 3-P

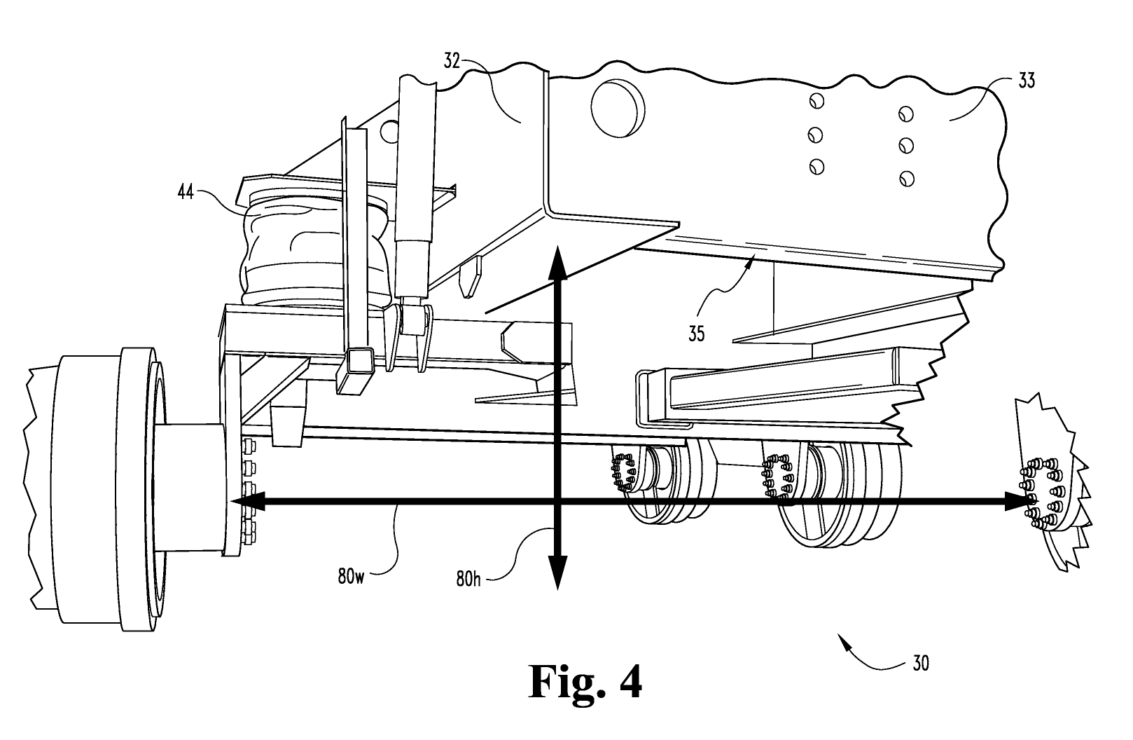

FIG. 4 is a line drawing representation of FIG. 4-P

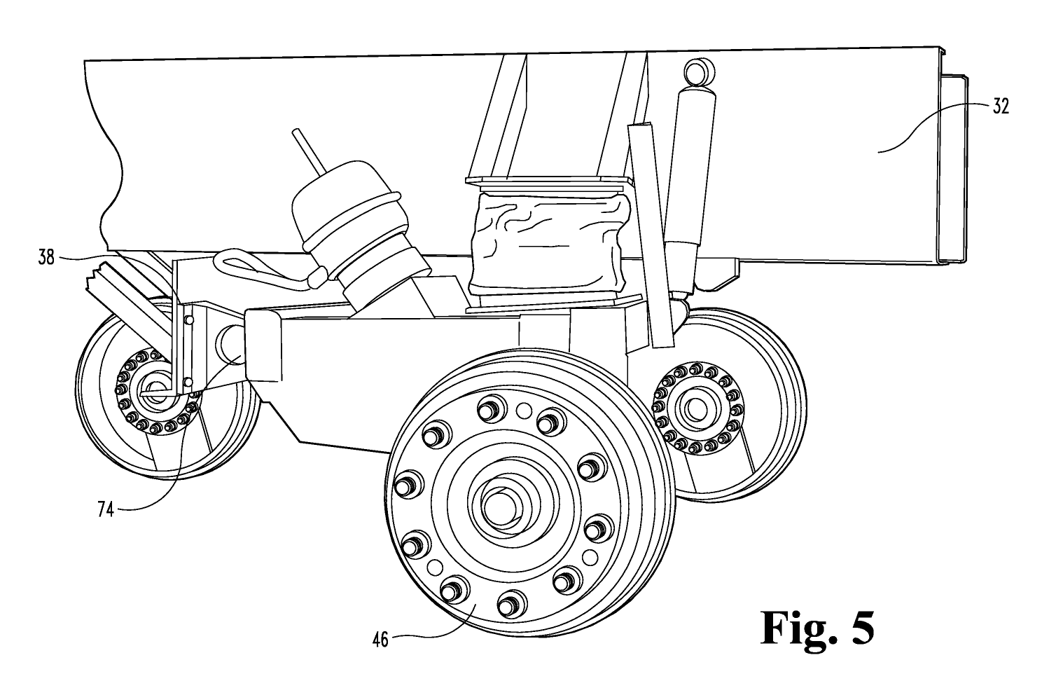

FIG. 5 is a line drawing representation of FIG. 5-P

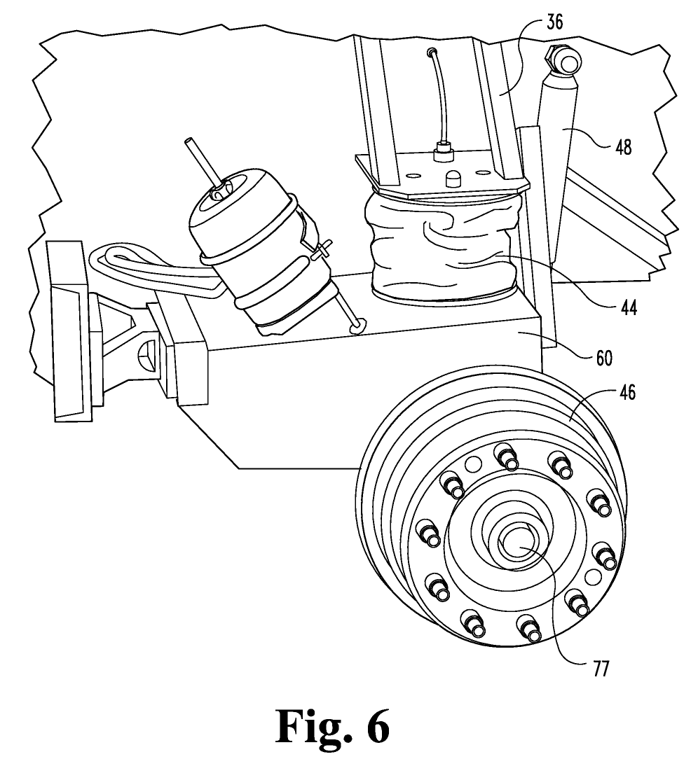

FIG. 6 is a line drawing representation of FIG. 6-P

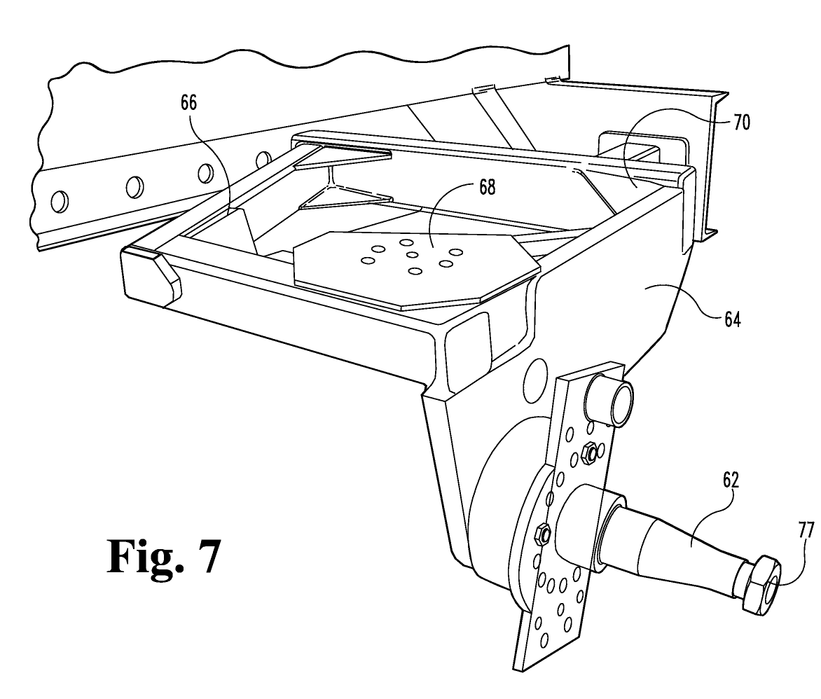

FIG. 7 is a line drawing representation of FIG. 7-P

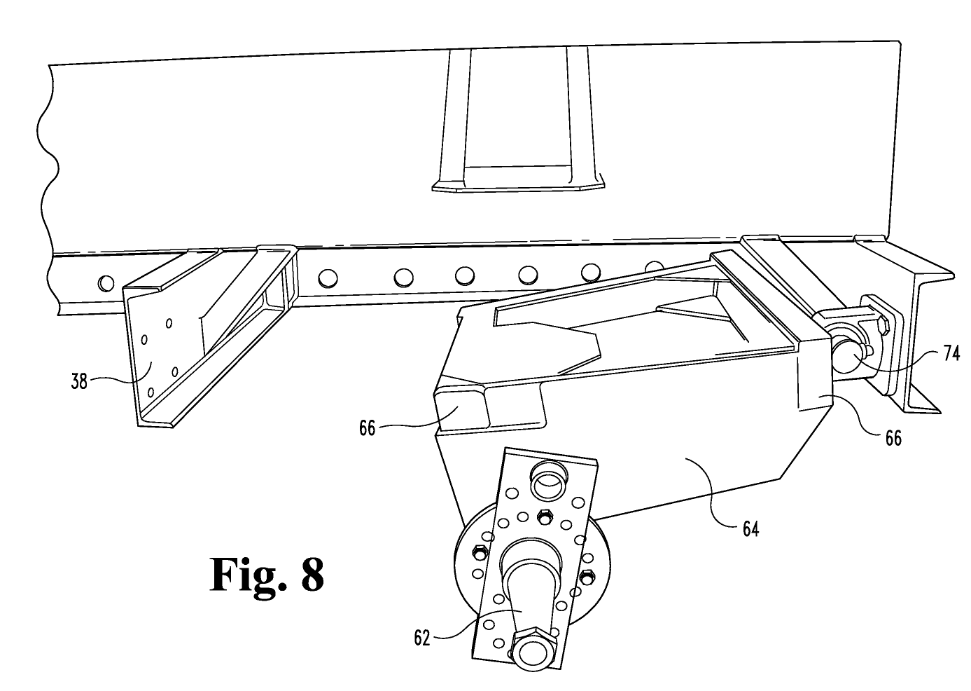

FIG. 8 is a line drawing representation of FIG. 8-P

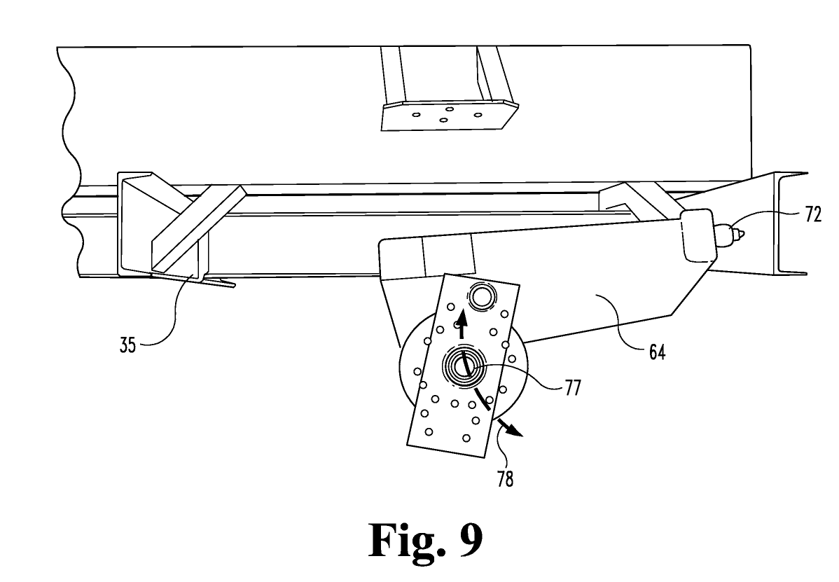

FIG. 9 is a line drawing representation of FIG. 9-P

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, etc.) may be stated herein, such specific quantities are presented as examples only. Further, discussion pertaining to a specific composition of matter, that description is by example only, does not limit the applicability of other species of that composition, nor does it limit the applicability of other compositions unrelated to the cited composition.

FIG. 1 shows a vehicle 20 including a tractor section and a trailer section. Trailer or payload section 22 includes a central container 24 that includes an underneath opening through which the operator of vehicle 20 dumps the contained load. This configuration of vehicle 20 is referred to a “belly dump” or “bottom dump” truck. Container 24 is supported on a frame 26 in the approximate middle of the payload section 22. The front of the payload section is supported by the rear wheels of the tractor section. The rear of payload section 22 is supported by a subchassis 28 that includes a suspension having a plurality of tires supporting the payload section 22 from the roadway. The tires and wheels are coupled to the subchassis 28 by various suspension components. The subchassis 28 of the vehicle 20 includes numerous components, both static and movable, located between the wheels. The ground clearance of subchassis 28 is largely established by these components, which can include axles, suspension assemblies, springs, brake components, and frame sections.

Referring to FIGS. 2-9, a vehicle 120 according to one embodiment of the present invention includes a subchassis 30 that provides similar support function as subchassis 28, but accomplishes many of these functions with greater clearance above the roadway.

Although an inventive subchassis 30 will be shown and described after reference to a particular exiting subchassis 28, it is understood that various embodiments of the present invention pertain to many other applications, including subchassis mounted forward of the container, and also trucks with a substantially integral frame (in contrast to the tractor trailer shown in FIG. 1) in which the inventive subchassis includes one or more pairs of wheels fore or aft of a bottom dumping container. Further, yet other embodiments of the present invention pertain to road vehicles of any type in which ground clearance is a consideration.

FIGS. 2-9 depict various views of various embodiments of the present invention. FIGS. 2, 3, and 4 show a subchassis 30 according to one embodiment of the present invention. Subchassis 30 includes a frame 31 comprising right and left side rails 32 interconnected by a plurality of cross members 33. Subchassis 30 is adapted and configured to integrate into a frame 126 of a vehicle 120. Subchassis 30 includes a top surface 34 that can support a payload. Subchassis 30 is integrated into vehicle 120 by being combined into frame 126, or including supporting a payload section 122 on top surface 34.

Subchassis 30 includes a plurality of upper spring brackets 36 and pivot support brackets 38 that are adapted and configured to interface with corresponding airbags and pivot couplings, respectively. As shown in FIGS. 2, 3, and 4, subchassis 30 provides upper spring brackets 36 and pivot support brackets 38 such that six pairs of tires 41 (not shown) coupled to wheels 40 (not shown) provide support to vehicle 120 from the roadway. Although a subchassis 30 has been shown and described including three pairs of opposing wheels, it is understood that the present invention contemplates single pairs of opposing wheels as well as multiple pairs of opposing wheels.

During normal operation of vehicle 120, the rotational axis 77 established by spindle 62 is generally below the pivot axis of the corresponding suspension arm 60. However, during jounce operation, the rotational axis may be momentarily above the pivot axis. In addition, other embodiments of the present invention contemplate a kneeling arrangement whereby the airbags 44 are deflated to permit the dump opening of container 24 to be located closer to the roadway.

Referring to FIGS. 3 and 4, one embodiment of the present invention provides for support of an opposing pair of wheels (represented by brake drums 46 and 46′) that are not interconnected with an axle. Preferably, each wheel of the corresponding opposing pair of wheels can move independently of the other of the pair of opposing wheels, relative to the subchassis frame. The interconnection between opposing wheels is through frame 31, and not by an axle.

By not incorporating an axle to interconnect an opposing pair of wheels, it is possible to have a ground clearance volume that extends across the width horizontally underneath the bottom surface 35 of the frame, as represented by arrow 80w. Further, the absence of an axle interconnecting opposing wheels also provides a vertical clearance 80h from the roadway to the bottom surface 35 of the subchassis frame. Referring to a subchassis such as subchassis 30 incorporating three pairs of axleless opposing wheels, there is a clearance volume underneath subchassis 30 that is generally defined by width 80w, height 80h, and the length from the forwardmost to the rearward most pair. It is understood that the distance 80h from about the bottom surface 35 of the frame to the roadway is greater than the distance shown in FIGS. 3 and 4 because those photographs lack the corresponding wheels and tires mounted on brake drums 46 and 46′.

FIGS. 5 and 6 show close-ups of a single suspended brake drum 46. A suspension arm 60 pivotal about a pair of elastomeric bushings 74 rotatable supports a brake drum 46. Suspension arm 60 is biasingly coupled to upper spring bracket of the frame of subchassis 30 by a spring or airbag 44. Further, a shock absorber 48 dampingly couples suspension arm 60 to the frame of subchassis 30.

FIGS. 7, 8, and 9 depict various viewing angles of a suspension arm 60 coupled to the frame 31 of subchassis 30. A suspension arm 60 is pivotally coupled to a pivot support bracket 38 by a pair of aligned inboard and outboard elastomeric bushings 74. Support bracket 38 extends outwardly from frame 26, such that suspension arm 60 is located outboard of the clearance volume 80. In one embodiment, suspension arm 60 is cantilevered aft from support bracket 38. Bushings 74 permit arm 60 to pivot about a pivot axis 72 that is located forward of the rotational centerline 77 of a spindle 62. Suspension arm 60, of one embodiment, is of the trailing arm variety. Further information about elastomeric bushings 74 can be found in U.S. Pat. No. 6,398,251, incorporated herein by reference.

Suspension arm 60 includes a structural peripheral frame 66 to which portions of the bushings 74 are attached. Located within the periphery of frame 66 is a lower spring support 68 that is biasingly coupled by airbag 44 to frame 31. Bushings 74 are attached to a support bracket 38 that is rigidly attached (such as by welding) to other members of frame 31.

Suspension arm 60 further includes a generally vertical plate 64 that extends from an outboard side of frame 66. A spindle 62 couples to plate 64 and rotatably supports braking equipment, a wheel, and a tire. Spindle 62 is cantilevered outward from plate 64, as best seen in FIG. 7. A plurality of corner stiffening plates 70 are shown in the corners of a generally rectangular frame 66. Although what is shown in FIGS. 7, 8, and 9 is an arm 60 that is a weldement, the present invention also contemplates arms fabricated by casting. As one example, suspension arm 60 may include structural features similar to the features shown in the suspension arm of U.S. Pat. No. 6,398,251.

Referring to FIG. 9, it can be seen that the rotational centerline 77 of spindle 62 sweeps a sector of a cylindrical arc as it pivots about pivot axis 72. It can be seen that this cylindrical sector can be extended into a cylindrical surface underneath bottom surface 35 of frame 31. This cylindrical surface is largely unobstructed by any static members beneath the frame.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. An apparatus for a vehicle chassis, comprising:
a frame including a bottom surface and opposing sides;
a first suspension arm pivotably supported about a first pivot axis on one side of said frame, said first arm including a first spindle providing a first rotational axis, the first pivot axis being located in front of the first rotational axis and above the bottom surface, the first rotational axis being located below the bottom surface; and
a second suspension arm pivotably supported about a second pivot axis on the other side of said frame, said second arm including a second spindle providing a second rotational axis, the second pivot axis being located in front of the second rotational axis and above the bottom surface, the second rotational axis being located below the bottom surface;
wherein the movement of each said arm relative to said frame is independent of the movement of the other said arm relative to said frame.

2. The apparatus of claim 1 wherein said first pivot axis is longitudinally placed along the one side at about the same longitudinal station as said second pivot axis.

3. The apparatus of claim 2 wherein said first pivot axis is coincident with said second pivot axis.

4. The apparatus of claim 1 wherein pivotal motion of said first spindle about said first pivot axis sweeps a cylindrically shaped surface under the bottom surface, and the cylindrically shaped surface is free of obstruction by said frame.

5. The apparatus of claim 4 wherein said first suspension arm is pivotably supported by a first bearing, and the cylindrically shaped surface free of obstruction is inboard of said first bearing.

6. The apparatus of claim 5 wherein said first suspension arm is pivotably supported by a second bearing aligned with said first bearing, said first bearing is an inboard bearing and said second bearing is an outboard bearing.

7. The apparatus of claim 5 wherein said first bearing includes an elastomeric bushing.

8. An apparatus for a vehicle chassis, comprising:
a frame including a top surface, a bottom surface, and opposing sides;
a first rear suspension arm pivotably supported about a first pivot axis on one side of said frame, said first arm including a first spindle providing a first rotational axis, the first pivot axis being located in front of the first rotational axis, the first rotational axis being located below the bottom surface; and
a second rear suspension arm pivotably supported about a second pivot axis on the other side of said frame, said second arm including a second spindle providing a second rotational axis, the second pivot axis being located in front of the second rotational axis, the second rotational axis being located below the bottom surface;
wherein pivotal motion of each said spindle about the corresponding said pivot axis sweeps a cylindrically shaped surface under the bottom surface from one opposing side to the other opposing side, and each cylindrically shaped surface is substantially free of static obstruction from said vehicle.

9. The apparatus of claim 8 wherein said first pivot axis is longitudinally placed along the one side at about the same longitudinal station as said second pivot axis.

10. The apparatus of claim 8 wherein said first pivot axis is coincident with said second pivot axis.

11. The apparatus of claim 8 wherein pivotal motion of said first spindle about said first pivot axis is independent of the pivotal motion of said second spindle about said second pivot axis.

12. The apparatus of claim 8 wherein said first suspension arm is pivotably supported by a second bearing aligned with said first bearing, said first bearing is an inboard bearing and said second bearing is an outboard bearing.
